(19) United States
(12) Patent Application Publication
(10) Pub. No.: US 2016/0090280 A1
(43) Pub. Date: Mar. 31, 2016

(54) TROLLEY JACK

(71) Applicant: MELCHOR GABILONDO, S.A., BERRIZ (Vizcaya) (ES)

(72) Inventor: Saul Gonzalez De Arriba, BERRIZ (Vizcaya) (ES)

(21) Appl. No.: 14/868,183

(22) Filed: Sep. 28, 2015

(30) Foreign Application Priority Data
Sep. 26, 2014 (EP) 14382363.1

(51) Int. Cl. B66F 5/04

(52) U.S. Cl. CPC B66F 5/04

(57) ABSTRACT

The present invention relates to a hydraulic trolley jack of the type that aids in lifting vehicles and that basically comprises a main body (1), a lifting element (2) capable of moving up or down with respect to the main body (1), an operating lever (3) that can be lowered through which the user operates the lifting element (2), interlocking means for fixing the operating lever (3) in the operative position thereof and automatic release means for automatically releasing said operating lever (3) such that it can be lowered on the main body (1) in a manner that is easy and comfortable for the user.

### TECHNICAL FIELD OF THE INVENTION

The invention relates to a trolley jack of the type that aids in lifting vehicles or other heavy objects and is widely used in vehicle workshops.

More specifically, the trolley jack of the present invention is of the type having an operating lever that can be lowered such that it can be folded when it is not operative, minimizing the space it occupies.

### BACKGROUND OF THE INVENTION

Trolley jacks are apparatus widely used in vehicle workshops or in other places where mechanical works for lifting heavy objects are performed.

Such jacks generally comprise a main body with respect to which there is arranged in a movable manner some type of lifting element which, when duly operated by means of a hydraulic system or the like, is capable of moving up, exerting enough force under the vehicle or heavy object for lifting same, as well as means allowing the controlled downward movement of said lifting element in order to prevent imbalance that may cause accidents when the lifting element is moved downward under load.

On the other hand, these jacks usually have an operating lever allowing the user to actuate the hydraulic system or the like and to subsequently move the lifting element up.

Said lever usually consists of a telescopic or non-telescopic arm of a considerable length which projects upwards in an operative position to provide the user with a comfortable grip zone that the user can pull on if he/she only wants to move the jack on its wheels or operate it to actuate the lifting mechanism when lifting a vehicle.

This, however, means that such jacks occupy a large amount of space when not in use, so they may be uncomfortable or even become a nuisance if the workshop space or the place in which the jacks are located is small.

To prevent this drawback, there were some jacks in which said lever pivots at its lower end so that it can folded on the main body of the jack, making jack storage easier as it occupies far less space.

However, the mechanism that enables said lever to pivot so that it can be lowered has the drawback of being completely manual, requiring an operator with certain skill. Therefore, some systems are known in which in order to produce said lowering, said lever must first be pulled up a certain length in order to bring it out of an interlocking point, at which time it can already be lowered.

This discomfort is combined with the fact that the same interlocking point which allows lowering the lever is sometimes also the point on which said lever must rotate or turn in order to operate the means allowing the controlled downward movement of the lifting element, so lowering the lever may cause the unwanted downward movement of said lifting element or vice versa, i.e., accidentally lowering said lever when trying to cause the downward movement of the lifting element.

Therefore, more experiment and practice in handling is still necessary in these last cases if involuntary movements that can delay the operations or, in the worst case, cause an accident, are to be prevented.

### DESCRIPTION OF THE INVENTION

The trolley jack object of the present invention solves the drawbacks of the state of the art mentioned above insofar as it allows lowering the operating lever easily without risk for the load or for the operator.

Specifically, the jack of the invention comprises interlocking means which allow fixing the operating lever in the operative position thereof so that the user can move the lifting element up.

On the other hand, the jack of the invention comprises automatic release means which, when operated, release the operating lever, which can then be easily and readily lowered without the user having to make any effort and making said lowering independent from the movement causing the controlled downward movement of the lifting element, preventing errors and allowing handling by an operator without said operator having a lot of previous experience.

More specifically, the trolley jack of the invention comprises a main body with a lifting element that is capable of moving up or down with respect to said main body through the action of the operating lever. To that end, said main body comprises in its rear part, opposite said lifting element, a lever holder to which the lower end of said operating lever is fixed and which activates the hydraulic mechanism responsible for causing the lifting element to move up.

Said lever holder comprises the interlocking means and automatic release means which allow retaining or releasing the operating lever, respectively, in order to provide two possible modes of operation, i.e.:
The structural rigidity of the lever holder/operating lever assembly for the operative phase of the jack, during which the interlocking means come into action; or
The automatic release of the operating lever of the lever holder by the user by operating the automatic release means in order to lower the operating lever and allow folding and storing the jack.

### DESCRIPTION OF THE DRAWINGS

To complement the description that is being made and for the purpose of aiding to better understand the features of the invention according to a preferred practical embodiment thereof, a set of drawings is attached as an integral part of said description in which the following is depicted with an illustrative and non-limiting character:

FIG. 1 shows a side elevational view in which a partial cut of the attachment between the operating lever and the lever holder was made in the position in which said operating lever is assembled and ready to be operated.

FIG. 2 shows a view such as that of FIG. 1 but in which the lever has been unlocked from the lever holder and in an intermediate lowered position.

FIG. 3 shows a view such as that of FIG. 2 in which the operating lever is in an intermediate lowered position but in which the interlocking means are completely retracted.

FIG. 4 shows a side view such as that of the preceding figures in which the operating lever is in a position completely lowered on the body of the jack.

FIG. 5 shows a perspective view of the jack of the present invention when said jack is in the operative position shown in FIG. 1.

### PREFERRED EMBODIMENT OF THE INVENTION

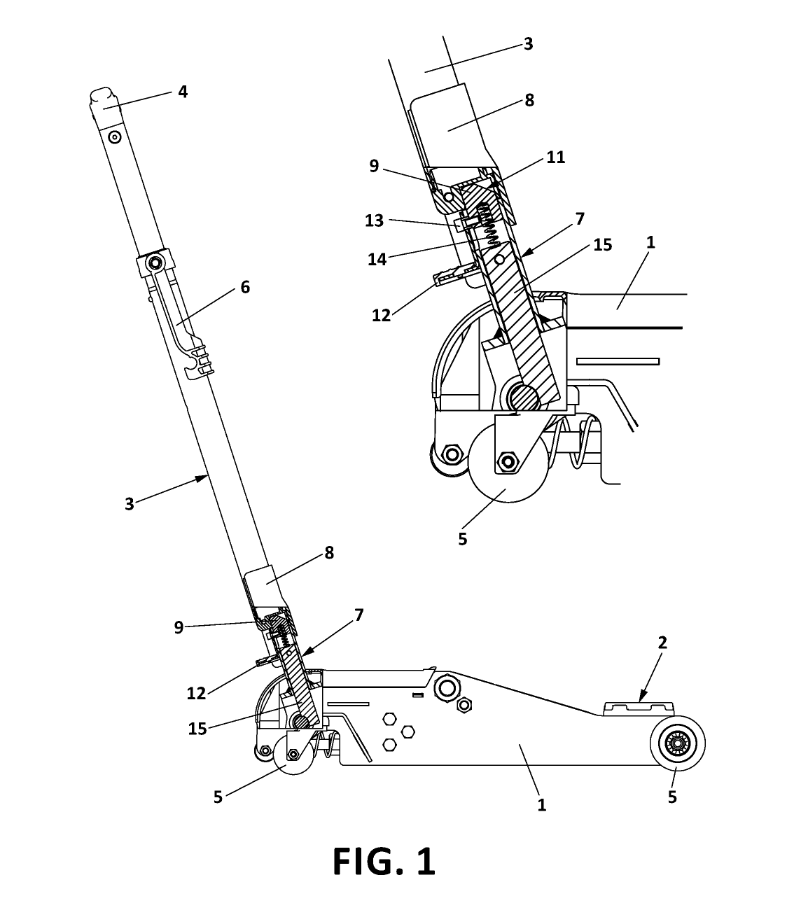

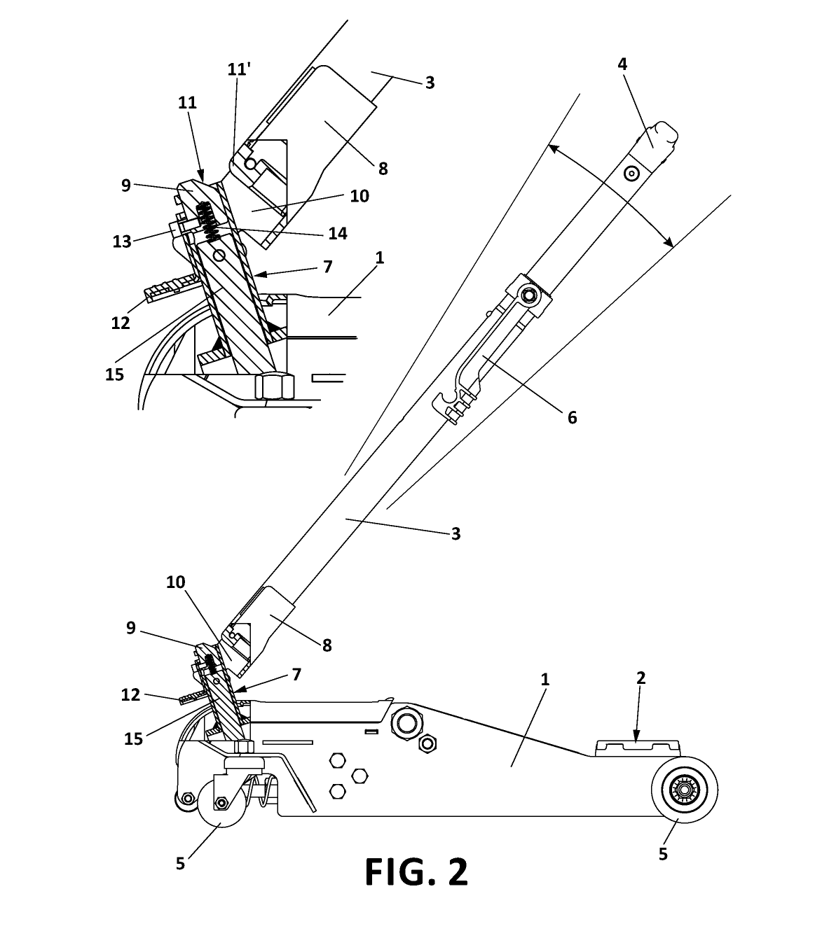

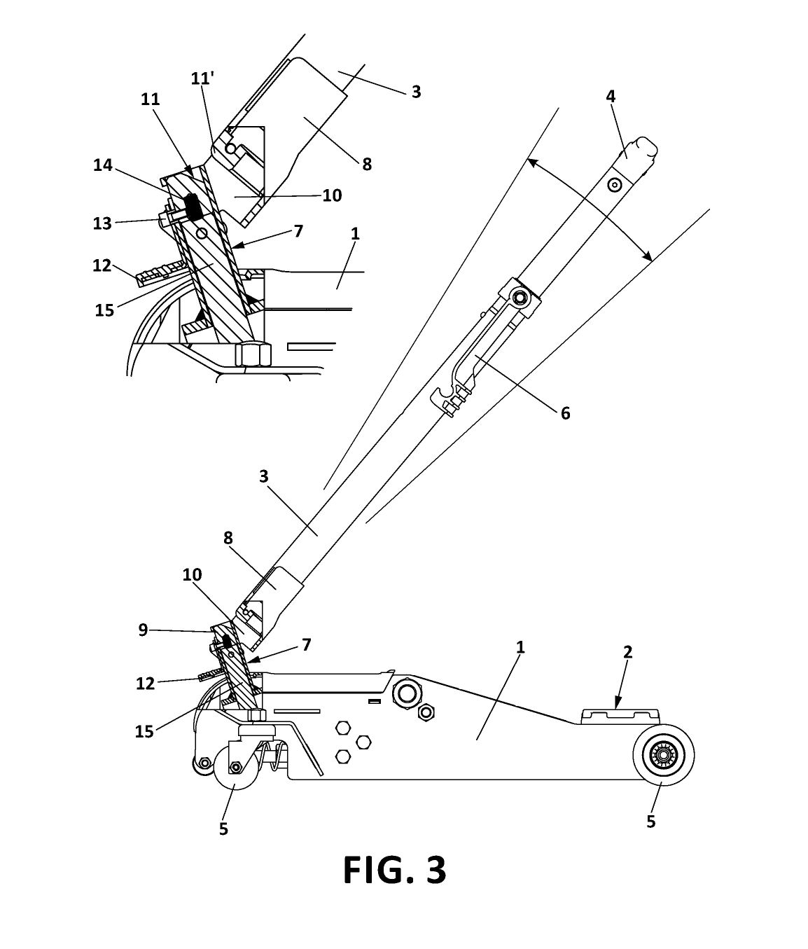

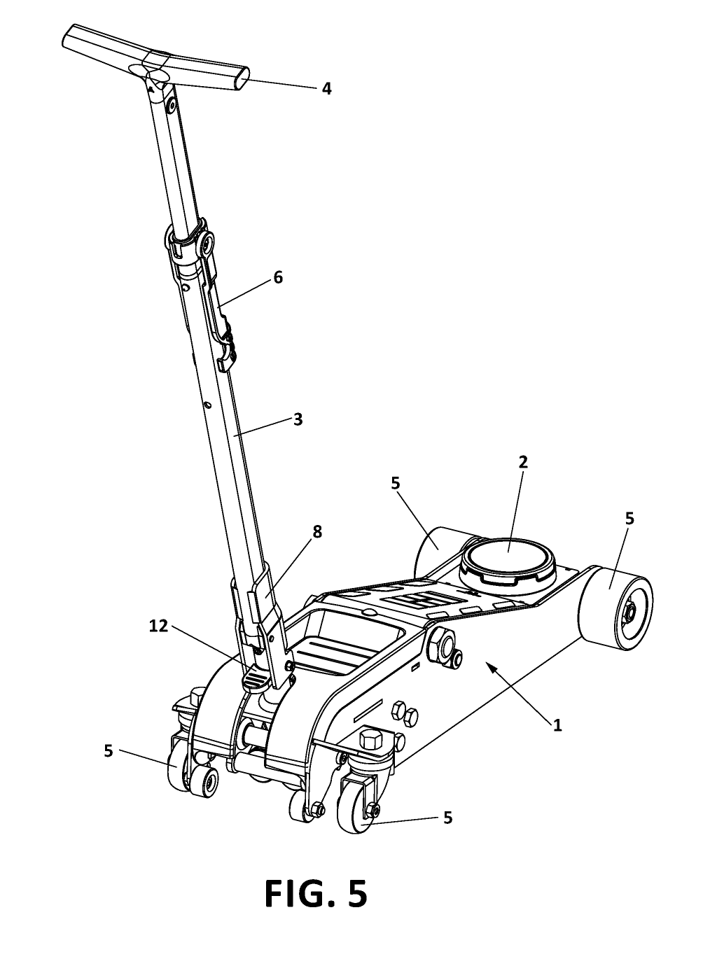

In view of the described drawings, it can be seen how the trolley jack of the invention comprises a main body (1) with a lifting element (2) that is capable of moving up or down with respect to said main body, which lifting element (2) is operated by the user through an operating lever (3) which, as can be seen in FIGS. 1 to 3 and 5, protrudes upwards from the main body (1) and which, according to a possible embodiment, can have a handle (4) or handlebar at its upper end in order to make gripping same easier.

More precisely, FIG. 1 shows a situation in which the operating lever (3) is in the operative position thereof, protruding upwards, ready to be operated by a user which wants to operate the lifting element (2) or cause the movement of the jack aided by the wheels or rolling elements (5).

As explained above, the jack comprises both interlocking means which allow fixing the operating lever (3) in the operative position thereof so that the user can actuate the lifting element (2), and automatic release means for automatically releasing said operating lever (3) which allow lowering same if it will not be used.

To that end and as can be seen in the drawings, particularly in FIGS. 1 to 4, the main body (1) comprises in its rear part, opposite the lifting element (2), a lever holder (7) to which the lower end (8) of said operating lever (3) is fixed in a swiveling manner and where said lever holder (7) activates the hydraulic mechanism (not depicted) responsible for causing said lifting element (2) to move up.

More specifically and as shown in FIGS. 1 to 4, the lever holder (7) is formed as a hollow tubular body open at its two ends which is partially introduced in the main body (1) of the jack and which can swivel about same, internally comprising a rigid elongated body (15) extending from a little over half the height of the lever holder (7) until the lower end thereof, protruding therethrough, such that when said lever holder (7) is lowered or operated by the user through the operating lever (3).

On the other hand, at the upper end of said lever holder (7) there is housed a latch (9) which is capable of moving longitudinally along the inside thereof from a lower position in which it abuts with the upper end of the elongated body (15) to an upper position in which it protrudes partially through the upper edge of the lever holder (7), upper position in which, when the operating lever (3) is raised, i.e., in the not lowered operative phase and therefore interlocked with the lever holder, the latch (9) is partially introduced in a cavity (10) which the operating lever (3) has at its lower end (8), causing the interlocking between operating lever (3) and lever holder (7) such that the user can, by operating the operating lever (3), move said lever holder (7) and, integrally and simultaneously, move the elongated body (15) responsible for operating the hydraulic mechanism causing the lifting element (2) to move up.

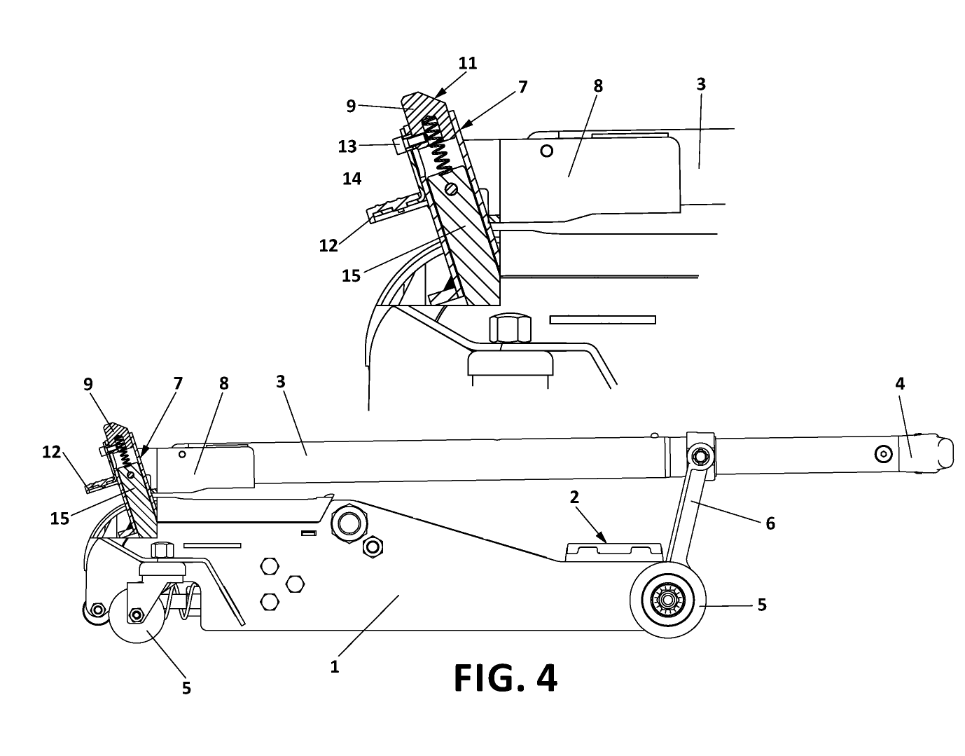

On the other hand, the latch (9) can also be in the same position, i.e., in the upper position in which it protrudes partially through the upper edge of the lever holder (7) when the operating lever (3) is lowered, as can be seen in FIG. 4.

That position in which the latch (9) protrudes through the upper edge of the lever holder (7) is the stand-by position as a result of the action of a spring-type elastic element (14) or the like keeping said latch (9) separated from the elongated body (15) as it is located between both as seen in FIGS. 1 and 4.

Therefore, starting from the position in which the latch (9) is in the stand-by position, i.e., protruding partially through the upper edge of the lever holder (7) when the operating lever (3) is raised and in a not lowered operative phase and therefore interlocked with the lever holder, if the user wants to fold the jack by lowering the operating lever (3), he/she must overcome the resistance of the elastic element (14) to allow said latch (9) to retract or move down the lever holder (7) and out of the cavity (10) which the operating lever (3) has at its lower end (8).

To that end, the jack of the present invention comprises a push element (12) integrally attached to the latch (9) by means of a screw (13) or the like which, when being operated, overcomes the resistance of the elastic element (14) and pushes the latch (9) in a direction such that it moves down to the lower part of the lever holder (7).

According to the embodiment shown in the drawings, said push element (12) is located in the rear lower part of the main body (1) of the jack, such that it can be comfortably operated by the user with hands or with feet while working, however, the possibility of operating the push element from the handle (4) of the operating lever through an intermediate operating system is not dismissed.

In contrast, starting from the position in which the operating lever (3) is lowered on the main body (1), if the user wants to place it in a vertical position to interlock it with the lever holder (7) and to thus change to the operative position, he/she will raise said operating lever (3) to the point at which the upper corner (11) of the latch (9) contacts the edge (11′) of the lower end (8) of the operating lever (3), at which time he/she must exert a certain force in order to overcome the friction between both, as well as the resistance of the elastic element (14) such that he/she causes said latch (9) to move down along the lever holder (7) until, the operating lever (3) being put in place such that its longitudinal axis coincides with the longitudinal axis of said lever holder (7), the latch (9) is introduced in the cavity (10) driven by the elastic element (14) and changing to the interlocking position described above.

According to a possible embodiment of the invention shown in the drawings, both the upper corner (11) of the latch (9) and the edge (11′) of the lower end (8) of the operating lever (3) are rounded in order to reduce the friction between both and therefore to also overcome the resistance of the elastic element (14) more easily. Nevertheless, when the operating lever (3) is to be interlocked with the lever holder (7) as described, the user can always operate the push element to overcome the resistance of the elastic element (14) and push the latch (9) in a direction such that it moves down to the lower part of the lever holder (7) instead of interlocking, overcoming the friction between the upper corner (11) of the latch (9) and the edge (11′) of the lower end (8) of the lever as explained.

According to also a possible embodiment shown in the drawings, the trolley jack comprises at least one securing element (6) for fixing the operating lever (3) when it is lowered with respect to the main body (1). According to a possible embodiment, said securing element (6) is connected in an articulated manner to said operating lever (3) at one of the ends thereof whereas the other end in the shape of a hook or the like, is secured to the axle of the wheels or rolling elements (5), as shown in FIG. 4.

The presence of this securing element (6) prevents unwanted decoupling of the operating lever (3), which makes handling the jack easier and increases user safety. Furthermore, if the jack is lightweight enough, it allows the user to hold it by the operating lever (3) itself and transport it with his/her bare hands, which in some occasions may be preferable than transporting same by moving it with the help of the wheels or rolling elements (5).

Finally, according to another possible embodiment, the operating lever (3) is telescopic so that its length is variable and can be adapted or adjusted both to the height of the user and to the length of the main body (1) when it is lowered thereon, preventing it from protruding and making the assembly more compact and reducing storage space.

1. Trolley jack comprising:
a main body (1);
a lifting element (2) capable of moving up or down with respect to the main body
an operating lever (3) that can be lowered through which the user operates the lifting element (2);
interlocking means for fixing the operating lever (3) in the operative position thereof; and
automatic release means for automatically releasing said operating lever (3) so that it can be lowered on the main body (1).

2. Trolley jack according to claim 1, wherein the interlocking means and automatic release means are located in a lever holder (7) to which the lower end (8) of said operating lever (3) is fixed in a swiveling manner and in that said lever holder (7) is partially introduced in the main body (1) of the jack such that, when operated, it activates the hydraulic mechanism responsible for causing the lifting element (2) to move up.

3. Trolley jack according to claim 2, wherein the lever holder (7) is formed as a hollow tubular body open at its two ends which internally comprises:
a rigid elongated body (15) extending from a little over half of the height thereof to the lower end thereof, protruding therethrough; and
a latch (9) located at the upper end which can move longitudinally along the inside thereof from a lower position in which it abuts with the upper end of the elongated body (15), to an upper position in which it protrudes partially through the upper edge of the lever holder (7).

4. Trolley jack according to claim 1, wherein the operating lever (3) has a cavity (10) intended for housing the latch (9) when the operating lever (3) is interlocked in the lever holder (7).

5. Trolley jack according to claim 3, wherein the latch is kept on the upper edge of the lever holder (7) and separated from the elongated body (15) by the action of an elastic element (14) located between both.

6. Trolley jack according to claim 3, further comprising a push element (12) integrally attached to the latch (9) which, when operated by the user, overcomes the resistance of the elastic element (14) and pushes the latch (9) in a direction such that it moves down to the lower part of the lever holder (7).

7. Trolley jack according to claim 3, wherein both an upper corner (11) of the latch (9) and an edge (11′) of the lower end (8) of the operating lever (3) are rounded for the purpose of reducing the friction between both when they contact one another in the operation of interlocking said operating lever (3) in the lever holder (7).

8. Trolley jack according to claim 1, wherein the push element (12) is located in the rear lower part of the main body (1) of the jack, or in the handle (4) of the operating lever (3).

9. Trolley jack according to claim 1, further comprising wheels or rolling elements (5).

10. Trolley jack according to claim 1, further comprising at least one securing element (6) for fixing the operating lever (3) when it is lowered with respect to the main body (1).

11. Trolley jack according to claim 10, wherein the securing element (6) is connected in an articulated manner to the operating lever (3) at one of the ends thereof and the other hook-shaped end is secured to the axle of the wheels (5).

12. Trolley jack according to claim 1, wherein the operating lever (3) is telescopic.
